(19) United States
(12) Patent Application Publication
(10) Pub. No.: US 2005/0073991 A1
(43) Pub. Date: Apr. 7, 2005

(54) Multiple wireless device synchronization server

(76) Inventors: Chad A. Roberts, Kirkland, WA (US); Troy W. Roberts, Kirkland, WA (US); Owen C. Stenseth, Kirkland, WA (US); Donald Shapko, Kirkland, WA (US)

Correspondence Address: DICKSTEIN SHAPIRO MORIN & OSHINSKY LLP, 2101 L Street, NW, Washington, DC, 20037, US

(21) Appl. No.: 10/367,702

(22) Filed: Feb. 19, 2003

Related U.S. Application Data
(60) Provisional application No. 60/357,133, filed on Feb. 19, 2002.

(51) Int. Cl. H04J 3/06

(52) U.S. Cl. 370/350; 370/503

(57) ABSTRACT

A device for facilitating the simultaneous synchronization of wireless devices such as Palm computing devices is disclosed. A host computer system running proprietary synchronization software is connected to multiple wireless device connection nodes. The computer system manages synchronization with multiple wireless devices simultaneously. During the synchronization process, data can be (i) transmitted from a central store to all wireless devices connected, (ii) from a central store to certain wireless devices connected based on pre-defined parameters, (iii) from all wireless devices to a central store, and (iv) from certain wireless devices to a central store based on pre-defined parameters.

### FIELD OF THE INVENTION

The invention relates to the simultaneous synchronization of wireless devices such as Palm handheld computing devices.

### BACKGROUND OF THE INVENTION

A wide variety of wireless devices, such as handheld computing devices, exist. In many instances, it is advantageous for multiple wireless devices to communicate and exchange data with a central data store, central processor or central controller simultaneously. Existing technology only permits a single wireless computing device to communicate with a single personal computer, or a single node on a computer network. However, a need exists for technology which enables communication between multiple wireless devices and a single personal computer or a single node on a network or another host station (e.g. controller, transceiver, computing means, or computer system) (“computer means”).

### BRIEF SUMMARY OF THE INVENTION

It is an object, to provide a computer means running synchronization software and connected to multiple wireless device connection nodes, manages synchronization with the multiple wireless devices simultaneously. During the synchronization process, data can be transmitted (i) from a storage device, such as a central storage unit, to all connected devices, (ii) from a storage device to certain devices connected based on pre-defined parameters, (iii) from all devices to a storage device, and/or (iv) from certain devices to a storage device based on pre-defined parameters.

The synchronization mechanism, which can be in the form of computer software, or a micro-coded hardware logic device (“synchronization means”), monitors and manages the communications with each wireless device connected at a node to the computer means. The synchronization means automatically detects user requests for synchronization and performs the necessary action(s).

In addition to the synchronization means, a synchronization management user interface has been created to allow a user, such as an administrator to (i) define the actions the synchronization means will perform, (ii) manage files collected from, and transferred to, the wireless devices, and (iii) manage multiple wireless user profiles.

### BRIEF DESCRIPTION OF THE DRAWINGS

The foregoing and other features and advantages of the invention will become more apparent from the detailed description of the exemplary embodiments of the invention given below in connection with the accompanying drawings in which:

FIG. 1 is a block diagram of the present invention;

FIG. 2 is a flowchart diagram illustrating the synchronization process;

FIG. 3 is a screen capture of the synchronization manager user interface showing details of a user profile; and

FIG. 4 is an additional screen capture of the synchronization user interface showing management of a data file collected from a wireless device.

### DETAILED DESCRIPTION OF THE INVENTION

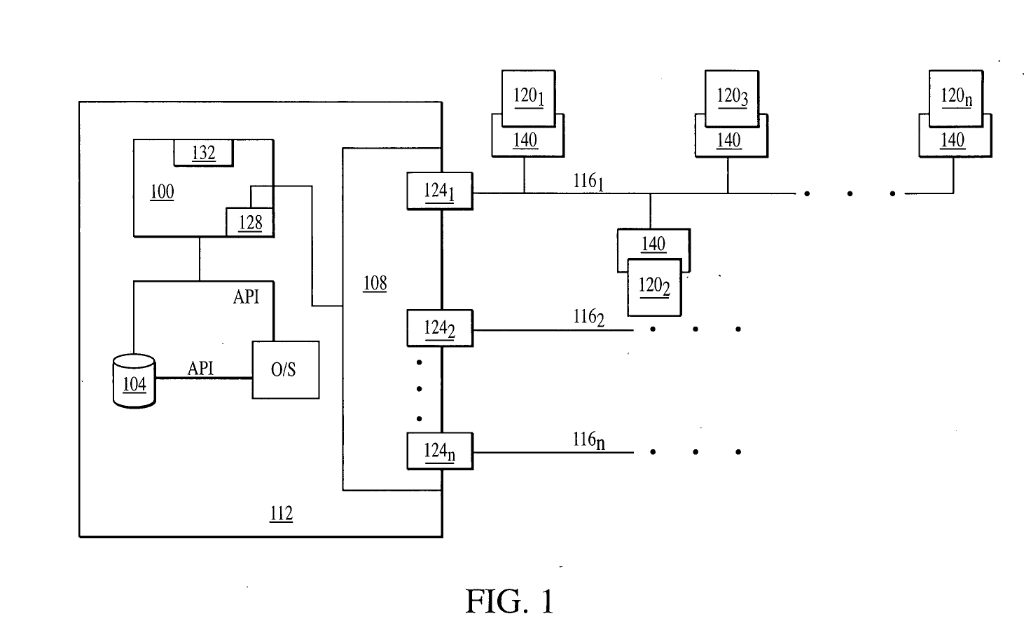

As shown in FIG. 1, the present invention consists of synchronization means 100, a synchronization manager 132, and a database management means 104 all of which reside on the computer means 112, as well as one or more wireless devices 120 connected to the computer means 112 through ports 124₁₋ₙ. The computer means 112 running the synchronization means 100 is a dedicated system and the synchronization means 100 is compiled for the Linux operating system, although a shared computer means running some other type of Operating System (“O/S means”)) could also be used.

Although numerous configurations are contemplated within the present invention, an example of the computer means 112 specifications include 1 GB RAM, a Linux-based O/S, an 18 GB fast SCSI disk, a fast network connection (i.e. 100 Mb/s), a minimum of 800 MHz microprocessor clock-speed, and numerous high speed ports 124 such as serial, USB, FireWire, 802.11b or 802.11a.

As stated, there is no specific requirement for the synchronization means 100 of the present invention to run only on the Linux O/S means. It could be ported to other forms O/s means presently known such as Unix (Sun Solaris, HP/IUX, etc), Windows, or Mac O/S or developed in the future. There would be routine changes required to interface the synchronization means 100 to the Application Program Interfaces (APIs) that each of these O/S means requires, such changes would only entail routine experimentation. For example, Linux and Windows NT both have different APIs for communicating to the serial ports so the portions of the synchronization means 100 that connect with the ports 124 would differ, but the part of the present invention that moves the data back and forth over that connection would stay the same.

The synchronization means 100 is generally indifferent to the specific types of physical connections 116 illustrated in FIG. 1. The present invention can communicate with wireless devices using Universal Serial Bus (USB), RS-232, InfraRed (IR), FireWire, 802.11a, 802.11b, BlueTooth, as well as other connection media (“connection means”). Doing so, however, requires some minimal modification to accommodate the required communication means protocols. The high-level transfer component 128 of the synchronization means 100 that actually transfers data back and forth over the physical medium 116 through port 124 has been abstracted such that it sees all of the different connection types as the same, because a specialized transfer component 108 handles the actual moving of the bits over the physical medium 116.

The synchronization means 100 is designed to seamlessly support the addition of new types of wireless devices as the wireless market evolves. The synchronization means 100 communicates over the physical connection means (i.e. USB, serial, BlueTooth, etc) to the device through a specialized software transfer component or protocol stack 108. These specialized transfer components 108 can be added or removed from the computer means 112 as required, much like a driver for a new video card on a PC. Like device drivers, the modules abstract the actual communications protocol by which a wireless device 120 communicates with the synchronization means 100, so that the high-level transfer component 128 can transfer data to and from the wireless device 120 while the specialized transfer components 108 determine what kind of wireless device is being synchronized and how to communicate with it. Examples of specialized transfer components 108 that can be loaded in the present invention include but are not limited to Palm OS drivers, PocketPC drivers, Psion/Symbian drivers, cellular phone drivers, as well as other wireless device drivers.

Each wireless device 120 has its own O/S means which may use differing methods to handle communication between the wireless device 120 and the computer means 112. Each manufacturer of operating systems for wireless devices 120 can have a completely different specification as to the actual process necessary for getting data to and from the wireless device 120. The standard mechanism for synchronizing data to the device as provided by the manufacturer is often proprietary and designed specifically to operate only on certain computer operating systems (i.e. Windows). Conversely, the specialized transfer components 108 of the present invention are instead designed to be O/S platform independent (i.e. can run on Windows, Linux, Unix, etc.), are optimized to be loaded only as needed, and are optimized to provide only the specific functionality required to exchange data with the connected wireless device 120.

Because new models of wireless devices 120 frequently come out, the computer means 112 must be updated with new specialized transfer components 108 as they are created. The computer means 112 can be updated via either downloads over the Internet (automatic or manually triggered), or can be updated via CD-ROM.

The synchronization means 100 supports sending and receiving any form of data supported by the wireless device connected to the system. For example, a user may wish to add or remove applications from a wireless device 120, add or remove databases supported by applications already on the wireless devices 120, or add or remove preference files that determine the behavior of the wireless device 120 under certain circumstances.

Further, the particular data to be synchronized can be determined on a “per device basis”, allowing customized data to be sent to individual devices even though multiple devices are being synchronized at the same time. To ensure that the correct data is exchanged with the correct wireless device 120, the synchronization means 100 will request an identifier 136 from the wireless device 120 once the communication connection is established. This identifier 136 can be associated with a particular profile maintained by the database management means 100 so that only data approved for transmission to a wireless device 120 matching that profile is synchronized. The specific information can be any information/markers used to uniquely identify a specific wireless device 120. The information is retrieved from the wireless device 120 and can then be used to distinguish between specific wireless devices. For example, some wireless devices 120 allow electronically querying for serial number, while other wireless devices 120 allow a SIM card identifier, or user name, model number, etc. The more unique the various identifiers (or combination of identifiers in some cases—i.e. a username+a model number) the better the match to an individual user/device profile on the computer means 112.

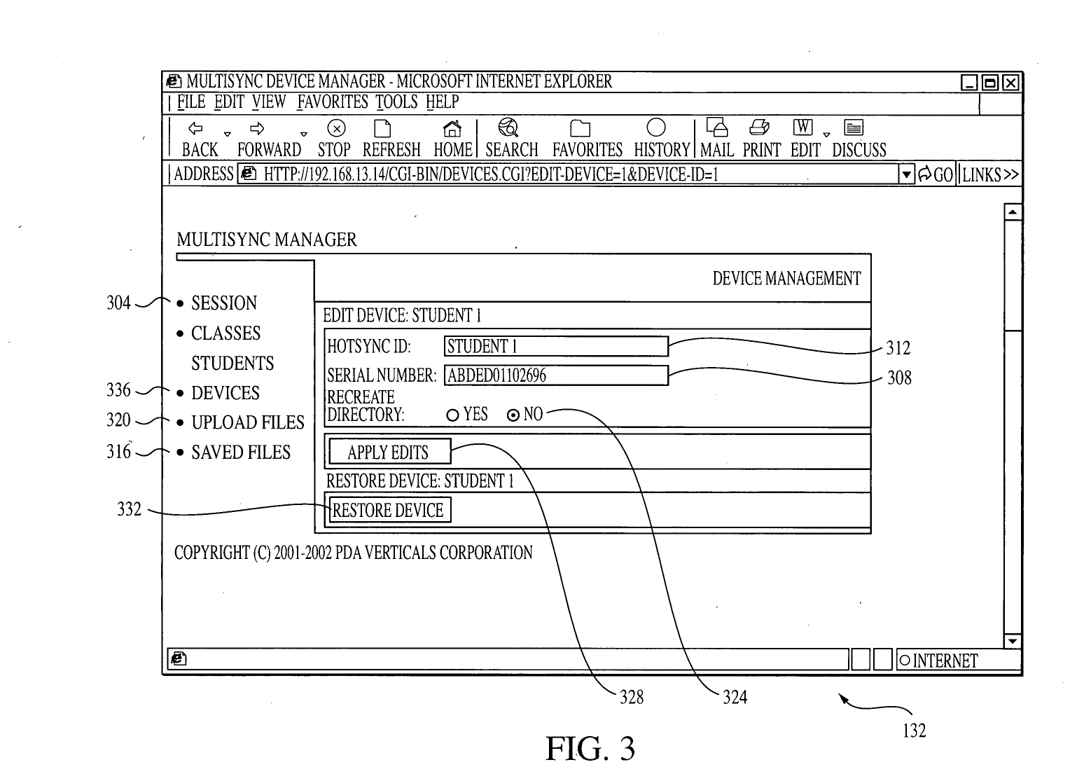

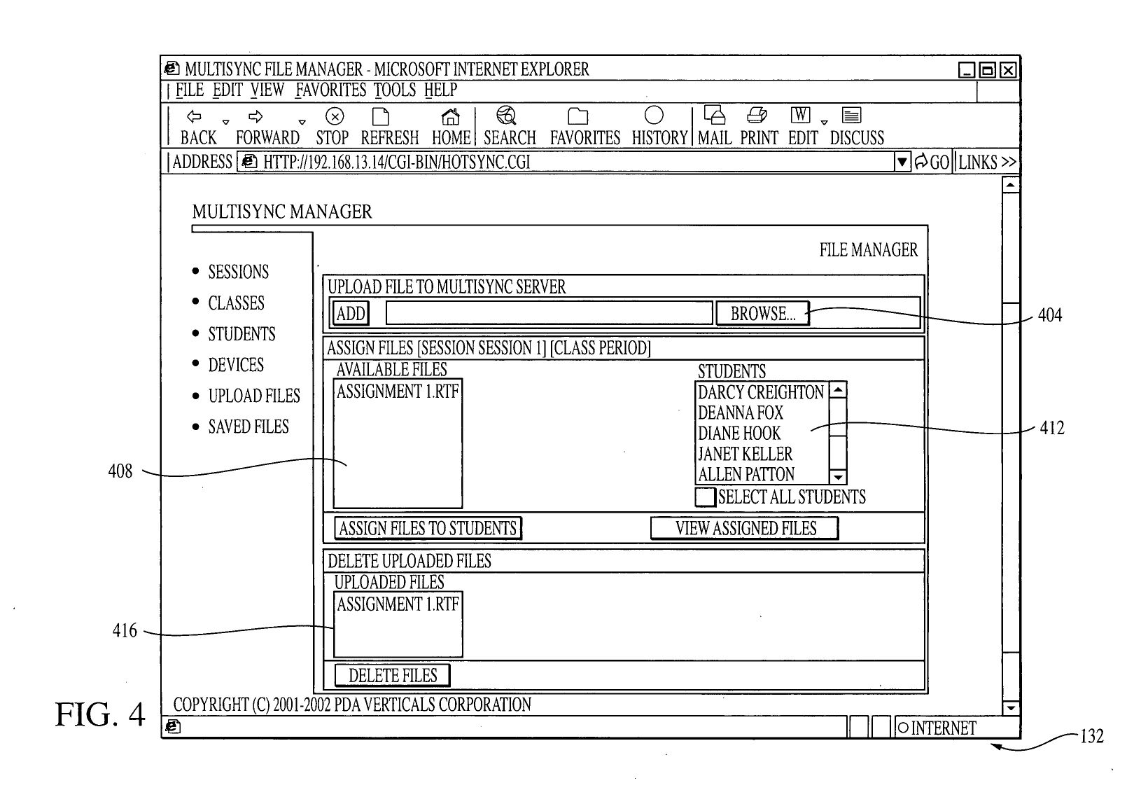

Profiles can be created and managed using the synchronization manager 132, an example of which is shown in FIGS. 3 and 4. The synchronization manager 132 also provides the interface for establishing which data is exchanged with each wireless device 120, and for determining where synchronized data is stored on the device and/or on the computer means 112, including network drives.

The database management means 104 can be a centralized data storage area that maintains all profile information, maintains historical records of previous synchronizations, and serves as a staging area for future synchronizations. Other database arrangements however are also contemplated by the present invention (“Database means”). Each time a synchronization event occurs, the database management 104 provides information as to whether a particular device is approved for connection, provides instructions to the synchronization means 100 as to what actions to perform during the synchronization, and provides locations for the data being received to be stored and for the data being sent to be accessed. Information maintained by the database management means 104 can be accessed and edited using the synchronization manager interface 132.

The number of devices that can be simultaneously synchronized is limited only by the number of port means 124 on the computer means 112 running the synchronization means 100. In an exemplary embodiment, Universal Serial Bus (USB) ports are employed, partly because USB ports can support up to 127 individual devices, and partly because of USB's high data transfer rates. In the diagram of FIG. 1, port 1241, is shown supporting wireless devices 120₁₋ₙ, while port 124₂ remains vacant. The wireless devices 120₁₋ₙ communicate with the port 124₁ through cradles 140₁₋ₙ over the physical connection medium 116.

The rate at which the various wireless devices 120 can be synchronized is limited by the physical connection medium 116. As stated, one embodiment of the present invention uses USB due to its speed, although the ability to easily add USB ports to the system and the low cost of USB cradles 140 are also factors.

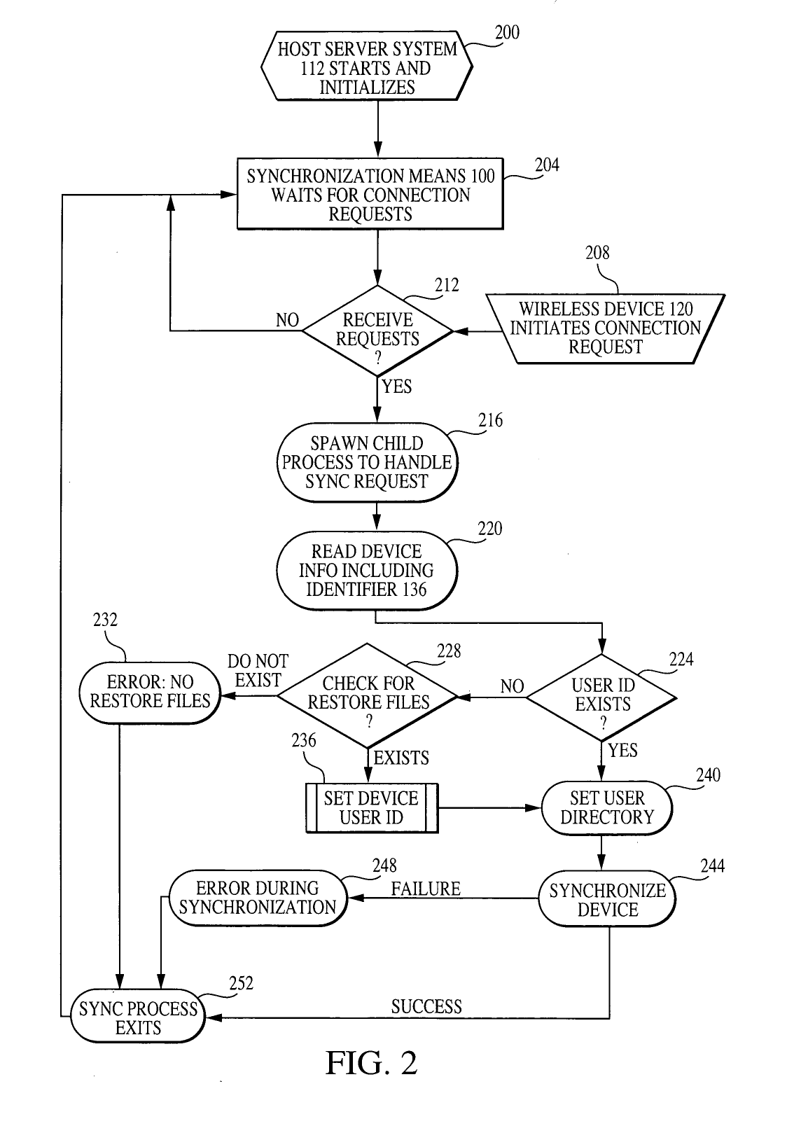

The life cycle of a typical synchronization process is shown in FIG. 2. Prior to any synchronization event, the computer means 112 must be loaded and initialized (step 200). The synchronization means 100 then waits at step 204 for a connection request from a wireless device 120. Upon receipt of a request, at step 216 the computer means 112 spawns a child process, as is well-known in the operating system art, to manage the request. At step 220 the synchronization means 100 communicates through synchronization manager 132 and operating system driver layer 108 to read information about the wireless device 120. At step 224, if a User ID exists for the wireless device 120, a user directory is set up. If no User ID exists, the synchronization means 100 checks for restore files. As shown in step 228, if no restore files exist, the synchronization means 100 exits the synchronization process. If restore files exist, a User ID is set for the wireless device 120 (step 236), the user directory is set (step 240), and the wireless device 120 is synchronized (step 244).

If a wireless device 120 has been completely reset, the computer means 112 will restore the wireless device 120 to a ‘default’ configuration, which can be set for an individual wireless device 120 or for a group of devices. Additionally, if a wireless device 120 does not have a unique electronic identifier (such as the “Serial Number” field 308 of FIG. 3) then the synchronization means 100 can either reject the wireless device 120, or assume it is a ‘pool’ device and assign it an identifier to use for future operations as shown in step 236.

Thus, the computer means 112 can be configured to allow only wireless devices 120 with known identifiers to connect, or can be configured to a more ‘promiscuous’ mode allowing any wireless device 120 to connect. However, the set of files transferred is always dependent on the quality of the unique identifiers, so while in promiscuous mode the computer means 112 might deliver no files, as shown in step 232. Alternatively, the computer means 112 could deliver only a generic fileset to devices that it cannot match, but then deliver additional more targeted files to wireless devices 120 it can uniquely identify. In either case, the files are delivered in step 240, which is labeled “Set User Directory”. This label is used because the information and/or files to synchronize with a unique wireless device 120 are stored in separate directories on the computer means 112. If the computer means 112 is able to make a unique match to a wireless device using its identifiers, it can then go into that devices' unique directory (or profile) and determine what additional files to send to or retrieve from that wireless device 120.

As shown in step 248, there can be instances where the synchronization process fails. Failure could occur, for example, if synchronization manager 132 and operating system driver layer 108 cannot recognize or negotiate with wireless device 120. In such a condition, the synchronization process ends unsuccessfully (step 252), the child process is halted and the synchronization means 100 returns to step (204).

FIGS. 3 and 4 show screen captures of an exemplary user interface of the synchronization manager 132. The implementation shown in FIGS. 3 and 4 is targeted toward an educational environment in which wireless devices are used to administer exams. However, the present invention is not limited only to such an environment, and the education environment shown in FIGS. 3 and 4 is for illustrative purposes only. It is also contemplated that the user interface function can be expressed in a wide number of mediums and through a variety of different interface arrangements. The sessions 304 refer to a specific group of students who will be using the present invention to administer an exam. For example, if a teacher had three classes of English, the first group can be referred to as session 1, the second referred to as session 2, and so on. The “Serial Number” field 308 identifies, where possible, the specific wireless device 120. The “HotSync ID” field 312 is a more English-like alias for the Serial Number field 308, and can be configured by the user of the wireless device 120. For example, the “HotSync ID” field 312 can be configured to be an individual student's name. The serial number is assigned by the manufacturer. A specific device can only ever have one serial number, and only one HotSync ID at any given time, but the HotSync ID can be changed by the user.

The “Saved Files” field 316 refers to the files that have been transferred from a wireless device 120 back to the computer means 112. This field could be useful for a user of the present invention, such as a teacher or professor, to create a test file (such as a quiz for example) and distribute it to students using the MultiSync Manager 132. The students would separately complete the quiz on an individual wireless device 120 and then synchronize with the computer means 112 using menu options (not shown) available on the wireless device 120. The completed quizzes that come back from the pool of wireless devices 120 are accessible by selecting the “Saved Files” field 316.

The fileset that can be restored to a specific wireless device 120 is configurable in that the computer means 112 can have different restore sets for different wireless devices 120. The restore set can contain any number and any type of files as long as they are compatible with the wireless device 120 they are being delivered to. The restoration process can, for example, be triggered by the “Restore Device” button 324 (FIG. 3).

The “Recreate Directory” radio button 324 works as follows. Selecting ‘yes’ deletes all files currently in the profile directory of the computer means 112 for that wireless device 120, and then repopulate the profile directory with default files if any have been set up. The “Apply Edits” button 328, if pressed, applies the changes in that panel of the synchronization manager 132 to a specified wireless device 120. On that panel, the operator could for example change the “HotSync ID” 312 of that wireless device 120, or change its “Recreate Directory” radio button 324 from “no” to “yes.”

The “Restore Device” button 332 downloads all files associated with a specific wireless device 120 from a directory on the computer means 112. If there are no files for that specific wireless device 120, there may be some files that are also ‘global’ that should be installed to any device that synchronizes. So the restore process restores global files (if any) plus device specific files (if any). Clicking on the “Devices” item 336 brings up all the wireless devices 120 connected to a particular computer means 112.

Continuing the example of using the present invention in an educational environment, clicking on the “Upload Files” item 320 of FIG. 3 would bring up another screen from the synchronization manager 132, as shown in FIG. 4. The act of uploading files in this case could mean receiving completed quizzes to students, for example. Accordingly, a “browse” button 404 allows the user to poll all existing wireless devices 120 currently connected to the computer means 112 to determine which students may have files available for uploading. The windows 408 and 412 allow viewing of available files and available students, respectively. The window 416 allows for the deleting of unwanted files which have already been uploaded.

It is important to re-iterate that the education examples shown in FIGS. 3 and 4 are only examples of possible ways to configure the present invention, and that the scope of the invention should not be considered as limited thereto.

While the invention has been described and illustrated with reference to specific exemplary embodiments, it should be understood that many modifications and substitutions can be made without departing from the spirit and scope of the invention. Accordingly, the invention is not considered as limited by the foregoing description but is only limited by the scope of the appended claims.

1. A system for synchronizing multiple wireless devices, comprising:
synchronization means, which coordinates communications between multiple wireless devices and a data storage means;
computer means connected to the data storage means and adapted to operate the synchronization means;
at least one node for connecting a plurality of wireless devices to the computer means running the synchronization software; and
database management means, for managing data related to past, current and future synchronizations wherein said plurality of wireless devices are simultaneously synchronized.

2. The system of claim 1, wherein said synchronization means further comprises:
a high-level transfer component; and
a synchronization manager.

3. The system of claim 2, wherein said computer means further comprises at least one specialized transfer component for managing the communication protocol between a specific wireless device and said computing means, thereby shielding said high-level transfer component from the necessity of knowing specific communication protocols.

4. The system of claim 2, wherein said specialized transfer components are operating system independent, loaded only as needed, and optimized to provide only the specific communication functionality needed by said wireless device and by said high-level transfer component.

5. The system of claim 4, wherein updates to said specialized transfer components are periodically loaded onto said computer means.

6. The system of claim 1, wherein said database management means maintains a profile holding desired characteristics of each of said plurality of wireless devices connected to said computer means.

7. The system of claim 1, wherein said synchronization means ensures that the correct data is sent to the correct wireless device partly by requesting an identifier from said wireless device.

8. The system of claim 2, wherein said synchronization manager provides an interface for allowing a user to choose where synchronized data is stored both on the wireless device and on the computing means.

9. The system of claim 1, wherein said database management means is a centralized data storage area that maintains profile information related to all wireless devices connected to said computer means, maintains historical records of previous synchronizations, and serves as a staging area for future synchronizations.

10. The system of claim 1, wherein each time a synchronization event occurs, said database management means provides information as to whether a particular device is approved for connection, provides instructions to the synchronization means as to what actions to perform during the synchronization, and provides locations for the data being received to be stored and for the data being sent to be accessed.

11. A method for synchronizing multiple wireless devices, comprising:
waiting for a request from a wireless device to be synchronized with a computer means;
upon receipt of a request, spawning a child process to handle said synchronization request;
reading information specific to said wireless device;
determining whether a user ID exists for said wireless device, and if not, checking if files should be restored from a computer means;
creating a user ID for said device if none existed; and
setting a user directory if necessary; and
synchronizing said wireless device with said computer means.

12. A method for synchronizing multiple wireless devices, comprising:
initiating a request for synchronizing a wireless device with a computer means, said initialization originating from said computer means;
spawning a child process to handle said synchronization request;
reading information specific to said wireless device;
determining whether a user ID exists for said wireless device, and if not, checking if files should be restored from a computer means;
creating a user ID for said device if none existed; and
setting a user directory if necessary; and
synchronizing said wireless device with said computer means.
